(19) United States
(12) Patent Application Publication
(10) Pub. No.: US 2026/0285144 A1
(43) Pub. Date: Sep. 24, 2026

(54) VEHICLE AIR FLAP SYSTEM

(71) Applicant: HYUNDAI MOBIS CO., LTD., Seoul (KR)

(72) Inventors: Jang Ho KIM, Yongin-si (KR); Jae Sup BYUN, Yongin-si (KR)

(73) Assignee: HYUNDAI MOBIS CO., LTD., Seoul (KR)

(21) Appl. No.: 19/085,388

(22) Filed: Mar. 20, 2025

(51) Int. Cl. B60K 11/08

(52) U.S. Cl. CPC B60K 11/085

(57) ABSTRACT

The present invention relates to an improved vehicle air flap system capable of preventing degradation of the design of a front portion of a vehicle. A vehicle air flap system includes a case including a cover in which a plurality of inlet holes disposed in parallel in each of a first row and a second row are formed, a flap unit including a plurality of first flaps disposed in the inlet holes of the first row and a plurality of second flaps disposed in the inlet holes of the second row, and an opening and closing device connected to the flap unit and configured to rotate the first flaps and the second flaps, and the opening and closing device includes a first flap link coupled to the first flap, a second flap link coupled to the second flap, and a moving block, a first end of which is pivotally connected to second end portions of the first flap link and the second flap link and configured to push or pull the first flap link and the second flap link while moving inside the case.

### BACKGROUND

### 1. Field of the Invention

The present invention relates to a vehicle air flap system.

### 2. Discussion of Related Art

In order to stably operate various heat exchangers in an engine compartment of a vehicle, external air has to be smoothly supplied into the engine compartment. However, when the vehicle travels at high speed, a large amount of external air is introduced at high speed, and thus air resistance becomes very large. Thereby, there is a problem that the fuel efficiency of the vehicle decreases.

In order to solve the problem, an air flap system capable of helping improve fuel efficiency by introducing driving wind, which is about to flow toward the engine compartment through a grille installed in front of the engine compartment of the vehicle, into the engine compartment or blocking the flow of the driving wind into the engine compartment has been developed.

The air flap system may include a housing coupled to a grille and having an inlet hole formed therein to allow driving wind to pass through, and an air flap disposed in the inlet hole formed in the housing.

However, the air flap system in the related art has a problem in that the design of a front portion of the vehicle is degraded since the air flap is disposed at the rear of the inlet hole formed in the housing to form a step with the housing.

### SUMMARY OF THE INVENTION

The present invention is intended to solve the problems described above and is directed to providing an improved vehicle air flap system capable of preventing degradation of the design of a front portion of a vehicle.

According to an aspect of the present invention, there is provided a vehicle air flap system including a case including a cover in which a plurality of inlet holes disposed in parallel in each of a first row and a second row are formed, a flap unit including a plurality of first flaps disposed in the inlet holes of the first row and a plurality of second flaps disposed in the inlet holes of the second row, and an opening and closing device connected to the flap unit and configured to rotate the first flaps and the second flaps, in which the opening and closing device includes a first flap link, a first end portion of which is pivotally coupled to the first flaps, a second flap link, a first end portion of which is pivotally coupled to the second flaps, and a moving block, a first end portion of which is pivotally connected to second end portions of the first flap link and the second flap link and configured to push or pull the first flap link and the second flap link while moving inside the case.

The vehicle air flap system may include a rotating shaft rotatably coupled to the case, and the opening and closing device may include a first opening and closing unit and a second opening and closing unit that are coupled to the rotating shaft and are simultaneously operated by the rotating shaft.

In a state where the first flaps and the second flaps open the inlet holes of the first row and the inlet holes of the second row, a portion of the moving block may be disposed at a rear of the rotating shaft in a direction in which the moving block moves.

The opening and closing device may include a first shaft link, a first end portion of which is connected to the rotating shaft to rotate according to the rotating shaft and a second shaft link, a first end portion of which is pivotally connected to a second end portion of the first shaft link, and a second end portion of which is pivotally connected to the first end portion of the moving block to push or pull the moving block according to movement of the first shaft link.

The case may include a housing that is coupled to the cover and accommodates the opening and closing device therein, and the housing may include a first accommodating portion configured to accommodate a second end portion of the moving block of the first opening and closing unit therein to be linearly movable and a second accommodating portion configured to accommodate a second end portion of the moving block of the second opening and closing unit therein to be linearly movable.

The housing of the case may include a first partition frame partitioning an internal space to form a plurality of air passage regions and a second partition frame disposed to intersect the first partition frame and partitioning each of the plurality of air passage regions into a plurality of sections, and the cover of the case may include a third partition frame forming the inlet holes of the first row and the inlet holes of the second row and a fourth partition frame partitioning each of the inlet holes of the first row and the inlet holes of the second row into a plurality of sections and the vehicle air flap system includes a fixed block that is coupled to the fourth partition frame of the cover and rotatably fixes the first flap and the second flap to the cover.

A disposition direction of the fixed block may be the same as a disposition direction of the fourth partition frame of the cover.

The first flap that is rotated to open the inlet holes of the first row and the second flap that is rotated to open the inlet holes of the second row may be disposed inside the cover and the housing.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a vehicle air flap system according to one embodiment of the present invention;

FIG. 2 is an exploded perspective view of the vehicle air flap system according to one embodiment of the present invention;

FIG. 3 is a perspective view of a housing;

FIG. 4 is a cross-sectional view showing the interior of a first accommodating portion of the housing;

FIG. 5 is a cross-sectional view showing the interior of a second accommodating portion of the housing;

FIG. 6 is a view showing a first fixing protrusion and a second fixing protrusion of a cover;

FIG. 7 is a view showing a state where a fixed block fixes first flaps and second flaps coupled to the cover;

FIG. 8 is a view showing a first opening and closing unit;

FIGS. 9A and 9B are views showing a moving block of the first opening and closing unit;

FIG. 10 is a view showing a second opening and closing unit;

FIGS. 11A and 11B are a view showing a moving block of the second opening and closing unit;

FIG. 12 is a view showing a first flap link and a second flap link of the second opening and closing unit;

FIG. 13 is a view showing a state where the moving block of the first opening and closing unit and the moving block of the second opening and closing unit are covered by the cover;

FIG. 14 is a view showing a state where the first opening and closing unit closes a first inlet hole and a second inlet hole;

FIG. 15 is a view showing a state where the first opening and closing unit opens the first inlet hole and the second inlet hole;

FIG. 16 is a view showing a state where the second opening and closing unit closes the first inlet hole and the second inlet hole;

FIG. 17 is a view showing a state where the second opening and closing unit opens the first inlet hole and the second inlet hole; and

FIG. 18 is a view showing a state where a portion of the moving block is disposed at the rear of a rotating shaft.

### DETAILED DESCRIPTION OF EXEMPLARY EMBODIMENTS

Since the present invention may be variously modified and embodied, particular embodiments thereof will be illustrated in the drawings and described. However, this is not intended to limit the present invention to the specific embodiments, and it should be understood to include all modifications, equivalents, and substitutes included in the spirit and scope of the present invention.

Although the terms including ordinal numbers such as first, second, or the like, may be used to describe various elements, these elements are not limited by these terms. These terms are only used to distinguish one element from another element. For example, without departing from the scope of the present invention, a second element could be termed a first element, and similarly, a first element could be termed a second element. The term “and/or” includes a combination of a plurality of related listed items or any of a plurality of related listed items.

It will be understood that when an element is referred to as being “coupled” or “connected” to another element, the element may be directly coupled or connected to the other element, or intervening elements may also be present. In contrast, it will be understood that when an element is referred to as being “directly coupled” or “directly connected” to another element, there are not intervening elements present.

In the description of embodiments, when one element is described as being formed “on” or “under” another element, “on” or “under” includes both a case in which the two elements are directly in contact with each other and a case in which at least one additional element is formed to be disposed between the two elements (indirectly). Further, when expressed as “on or under”, the expression may include the meaning of not only an upward direction but also a downward direction based on one element.

The terms used in the present application are merely provided to describe specific embodiments, and are not intended to limit the present invention. The singular forms are intended to include the plural forms as well, unless the context clearly indicates otherwise. In the present application, it will be understood that terms “include,” “have,” or the like are intended to specify the presence of features, integers, steps, operations, elements, components, and/or combinations thereof stated in the specification, but do not preclude the possibility of the presence or addition of one or more other features, integers, steps, operations, elements, components, or combinations thereof in advance.

Unless otherwise defined, all terms used herein, including technical or scientific terms, have the same meaning as commonly understood by those of ordinary skill in the art to which the present invention belongs. Terms, such as those defined in commonly used dictionaries, should be interpreted as having a meaning that is consistent with their meaning in the context of the related art and will not be interpreted in an idealized or overly formal sense unless expressly so defined herein.

Hereinafter, a vehicle air flap system will be described in detail with reference to the accompanying drawings, but identical or corresponding components are denoted by the same reference numerals regardless of figure numbers, and redundant descriptions thereof will be omitted.

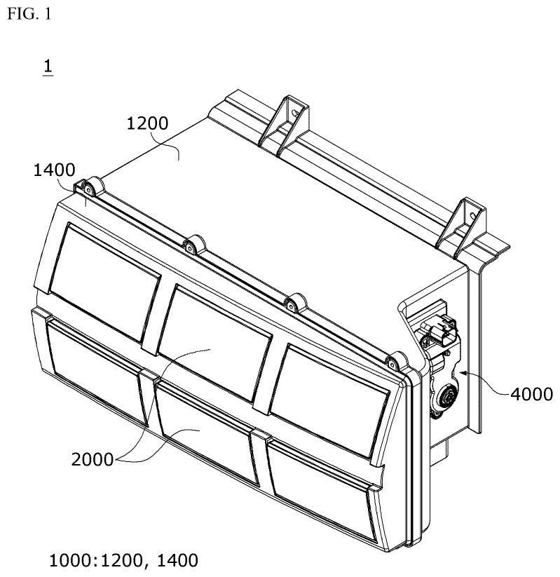

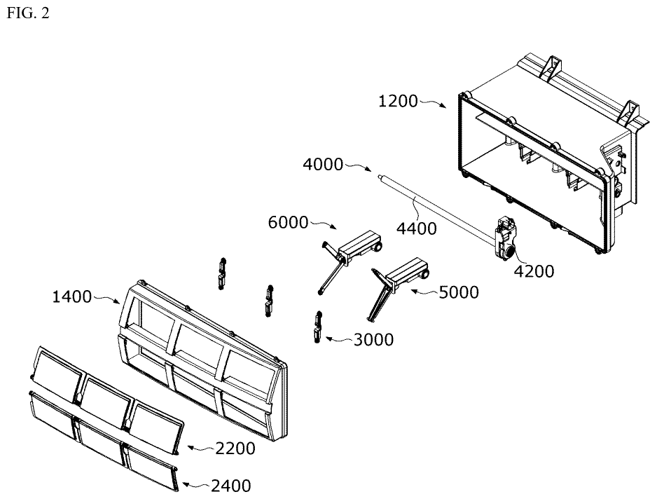

FIG. 1 is a perspective view of a vehicle air flap system according to one embodiment of the present invention, and FIG. 2 is an exploded perspective view of the vehicle air flap system according to one embodiment of the present invention.

Referring to FIGS. 1 and 2, a vehicle air flap system 1 according to one embodiment of the present invention may be disposed on a front portion of a vehicle to allow driving wind generated when the vehicle is traveling to flow into or block the interior of the vehicle. The vehicle air flap system 1 includes a case 1000, a flap unit 2000, a fixed block 3000, a rotating unit 4000, and an opening and closing device.

The case 1000 may support the remaining components of the vehicle air flap system 1 excluding the case 1000. The case 1000 may include a housing 1200 and a cover 1400.

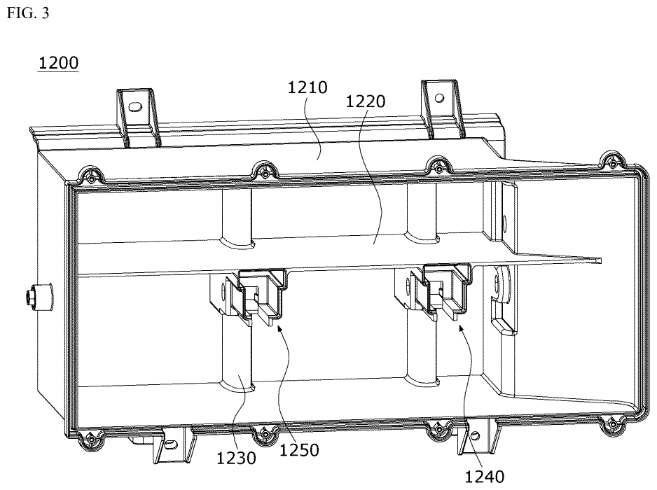

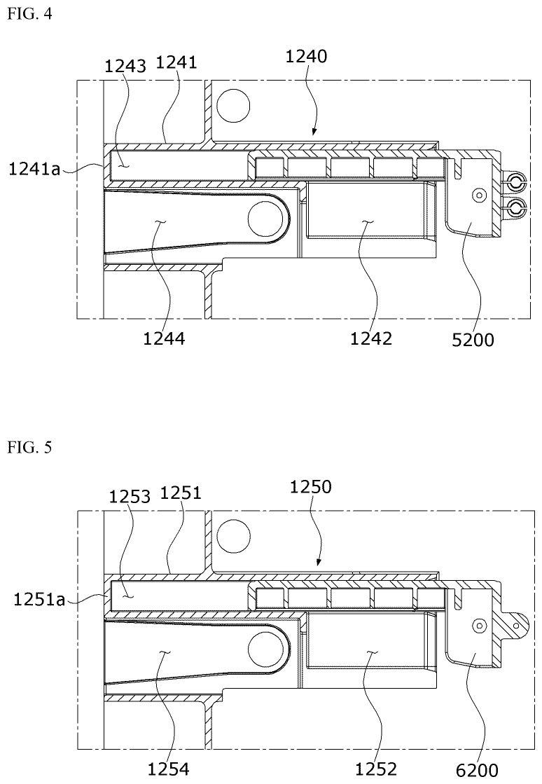

FIG. 3 is a perspective view of the housing, FIG. 4 is a cross-sectional view showing the interior of a first accommodating portion of the housing, and FIG. 5 is a cross-sectional view showing the interior of a second accommodating portion of the housing.

Referring to FIGS. 1 to 3, the housing 1200 may be coupled to the cover 1400, and may support the cover 1400. In addition, the housing 1200 may accommodate an opening and closing device therein, and may support the rotating unit 4000. The housing 1200 may include a main frame 1210, a first partition frame 1220, a second partition frame 1230, a first accommodating portion 1240, and a second accommodating portion 1250.

The main frame 1210 may be a component that forms the exterior of the housing 1200. The main frame 1210 may have a hollow shape to accommodate air passing through the cover 1400 by the flap unit 2000. That is, the main frame 1210 may be a passage that allows the driving wind to flow into internal components of the vehicle. The main frame 1210 may be disposed in a width direction intersecting with a longitudinal direction from a passenger compartment (not shown) of the vehicle toward an engine compartment (not shown). Here, the width direction may refer to a direction from a driver's seat of the vehicle to a passenger seat.

The first partition frame 1220 may be disposed inside the main frame 1210. The first partition frame 1220 may partition the internal space to form a plurality of air passage regions. Thereby, the main frame 1210 may be partitioned into a space of a first row and a space of a second row in a height direction perpendicular to the longitudinal direction and width direction. In the present embodiment, a plurality of air passage regions are exemplified as being formed in the housing 1200 by the first partition frame 1220, but the present embodiment is not limited thereto. Depending on the number of first partition frames 1220 disposed inside the main frame 1210, two or more air passage regions may be formed inside the main frame 1210.

The second partition frame 1230 may be disposed inside the main frame 1210. A plurality of second partition frames 1230 may be provided. The plurality of second partition frames 1230 may be disposed in parallel in the width direction. The plurality of second partition frames 1230 may be disposed to intersect the first partition frame 1220. By the second partition frames 1230, the space of the first row may be partitioned into a plurality of sections, and the space of the second row may be partitioned into a plurality of sections. That is, the second partition frames 1230 may partition the plurality of air passage regions formed inside the housing 1200 into a plurality of sections in the width direction.

Referring to FIGS. 3 and 4, the first accommodating portion 1240 may movably accommodate a portion of the opening and closing device therein. More specifically, the first accommodating portion 1240 may accommodate a moving block of a first opening and closing unit 5000 to be described below to be linearly movable therein. The first accommodating portion 1240 may include a first support unit 1241, a 1-1 groove 1242, a 1-2 groove 1243, and a 1-3 groove 1244.

The first support unit 1241 may be supported by the first partition frame 1220 and the second partition frame 1230. The first support unit 1241 may be composed of a combination of a plurality of frames. The first support unit 1241 may be disposed in the longitudinal direction. The first support unit 1241 may include a first stopper frame 1241a.

The first stopper frame 1241a is one of a plurality of frames constituting the first support unit 1241, and the first stopper frame 1241a may close one open side formed by the first support unit 1241. The first stopper frame 1241a may come into contact with a first moving block 5200 to be described below to block the movement of the first moving block 5200.

The 1-1 groove 1242, the 1-2 groove 1243, and the 1-3 groove 1244 may be formed inside the first support unit 1241. That is, the shapes of the 1-1 groove 1242, the 1-2 groove 1243, and the 1-3 groove 1244 may be determined by the shape of the first support unit 1241. The 1-1 groove 1242 may form a space in which a first body 5210 and a second body 5220 of the first moving block 5200 of the opening and closing device, which will be described below, may move. The 1-2 groove 1243 may be connected to the 1-1 groove 1242, and may form a space in which the second body 5220 of the first moving block 5200 to be described below may move. The 1-3 groove 1244 may be connected to the 1-1 groove 1242, and may be separated from the 1-2 groove 1243 by one of the frames constituting the first support unit 1241. The 1-3 groove 1244 may form a space in which a rotating shaft 4400, a first shaft link, and a second shaft link, which will be described below, may rotate or move.

Referring to FIGS. 3 and 5, the second accommodating portion 1250 may be spaced apart from the first accommodating portion 1240 in the width direction. The second accommodating portion 1250 may accommodate a portion of the opening and closing device therein to be movable. More specifically, the second accommodating portion 1250 may accommodate a moving block of a second opening and closing unit 6000 to be described below to be linearly movable therein. The second accommodating portion 1250 may include a second support unit 1251, a 2-1 groove 1252, a 2-2 groove 1253, and a 2-3 groove 1254.

The second support unit 1251 may be supported by the first partition frame 1220 and the second partition frame 1230. The second support unit 1251 may be composed of a combination of a plurality of frames. The second support unit 1251 may be disposed in the longitudinal direction. The second support unit 1251 may include a second stopper frame 1251a.

The second stopper frame 1251a is one of a plurality of frames constituting the second support unit 1251, and the second stopper frame 1251a may close one open side formed by the second support unit 1251. The second stopper frame 1251a may come into contact with a second moving block 6200 to be described below to block the movement of the second moving block 6200.

The 2-1 groove 1252, the 2-2 groove 1253, and the 2-3 groove 1254 may be formed inside the second support unit 1251. That is, the shapes of the 2-1 groove 1252, the 2-2 groove 1253, and the 2-3 groove 1254 may be determined by the shape of the second support unit 1251. The 2-1 groove 1252 may form a space in which a fifth body 6220 and a sixth body 6230 of the second moving block 6200 of the opening and closing device, which will be described below, may move. The 2-2 groove 1253 may be connected to the 2-1 groove 1252 and may form a space in which the sixth body 6230 of the second moving block 6200 to be described below may move. The 2-3 groove 1254 may be connected to the 2-1 groove 1252, and may be separated from the 2-2 groove 1253 by one of the frames constituting the second support unit 1251. The 2-3 groove 1254 may form a space in which the rotating shaft 4400, a third shaft link, and a fourth shaft link, which will be described below, may rotate or move.

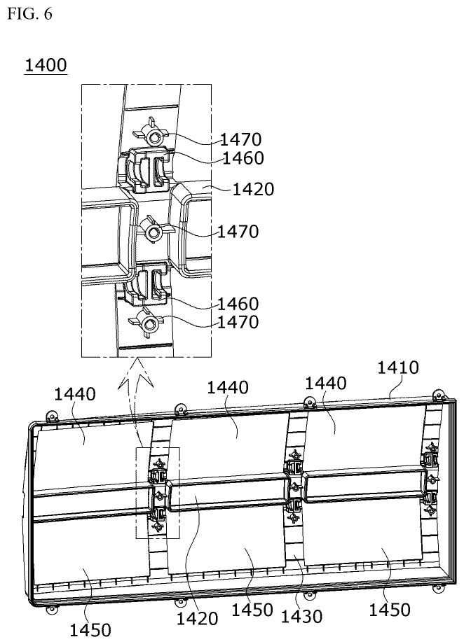

FIG. 6 is a view showing a first fixing protrusion and a second fixing protrusion of the cover.

Referring to FIGS. 1, 2, and 6, the cover 1400 may be coupled to the housing 1200. The cover 1400 may include a cover body 1410, a third partition frame 1420, a fourth partition frame 1430, a first inlet hole 1440, a second inlet hole 1450, a first fixing protrusion 1460, and a second fixing protrusion 1470.

The cover body 1410 may form the exterior of the cover 1400. The cover body 1410 may be disposed in the width direction, and may be coupled to the main frame 1210 of the housing 1200. The cover body 1410 may be disposed at the front of the housing 1200 in the longitudinal direction. The cover body 1410 may have a hollow interior and have a shape in which one side and the other side are open in the longitudinal direction.

The third partition frame 1420 may be disposed on the cover body 1410 in the width direction. The third partition frame 1420 may partition a region in the cover body 1410 where the inflow of driving wind begins. Thereby, the cover body 1410 may be partitioned into a space of the first row and a space of the second row in the height direction. That is, the third partition frame 1420 may form first inlet holes 1440 which are the inlet holes of the first row and second inlet holes 1450 which are the inlet holes of the second row.

A plurality of fourth partition frames 1430 may be provided. The plurality of fourth partition frames 1430 may be disposed in parallel in the width direction. The fourth partition frames 1430 may partition a region in the cover body 1410 where the inflow of driving wind begins. More specifically, the fourth partition frames 1430 may partition each of the inlet holes of the first row and the inlet holes of the second row formed in the cover body 1410 by the third partition frames 1420 into a plurality of rows.

As described above, the first inlet hole 1440 may be formed by the third partition frame 1420 and the fourth partition frame 1430. That is, a plurality of first inlet holes 1440 may be formed in the cover body 1410 in the width direction. The plurality of first inlet holes 1440 may be an upper space among a plurality of spaces partitioned by the third partition frame 1420. The first inlet holes 1440 are a space that guides the driving wind generated when the vehicle is traveling into the interior of the cover body 1410, and may be opened or closed by the flap unit 2000.

In addition, as described above, the second inlet hole 1450 may be formed by the third partition frame 1420 and the fourth partition frame 1430. That is, a plurality of second inlet holes 1450 may be formed in the cover body 1410 in the width direction. The plurality of second inlet holes 1450 may be a lower space among a plurality of spaces partitioned by the third partition frame 1420. The second inlet holes 1450 are a space that guides the driving wind generated when the vehicle is traveling into the interior of the cover body 1410, and may be opened or closed by the flap unit 2000.

The first fixing protrusion 1460 may be disposed in a region where the third partition frame 1420 and the fourth partition frame 1430 intersect. The first fixing protrusion 1460 may rotatably support each of flaps of the flap unit 2000 to be described below. A space in which each flap is accommodated in the first fixing protrusion 1460 may be closed by the fixed block 3000.

The second fixing protrusion 1470 may protrude from the fourth partition frame 1430. The second fixing protrusion 1470 may be coupled to the fixed block 3000 to support the fixed block 3000. The second fixing protrusion 1470 may have a cylindrical shape, but is not limited thereto. A plurality of second fixing protrusions 1470 are provided, and the plurality of second fixing protrusions 1470 may be spaced apart from each other with the third partition frame 1420 interposed therebetween.

In this way, the case 1000 may serve as a passage for introducing the driving wind generated during traveling into the interior of the vehicle through the cover 1400 in which a plurality of inlet holes disposed in parallel in each of the first row and the second row are formed.

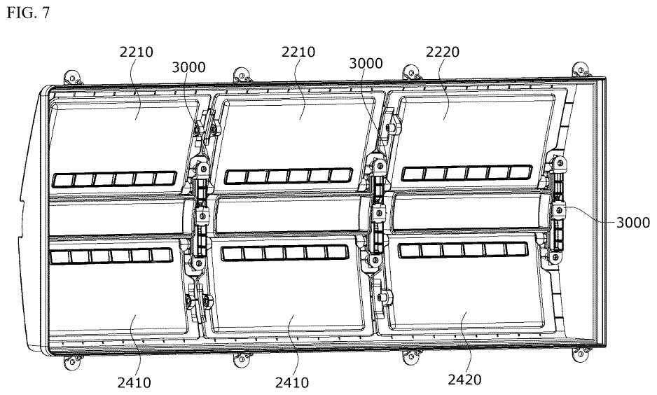

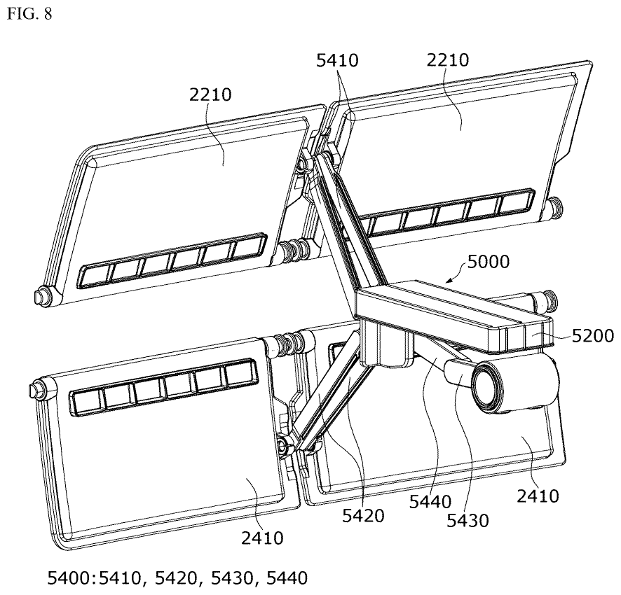

FIG. 7 is a view showing a state where the fixed block fixes first flaps and second flaps coupled to the cover.

Referring to FIGS. 1, 2, and 7, the flap unit 2000 may include a plurality of first flaps 2200 disposed in the inlet holes of the first row (first inlet holes 1440) formed in the cover 1400 and a plurality of second flaps 2400 disposed in the inlet holes of the second row (second inlet holes 1450).

The plurality of first flaps 2200 may be disposed in the width direction, and may be respectively disposed in the first inlet holes 1440 formed in the cover 1400. The first flaps 2200 may open and close the first inlet holes 1440 through the first opening and closing unit 5000 and the second opening and closing unit 6000 of the opening and closing device. The plurality of first flaps 2200 may include a 1-1 flap 2210 coupled to the first opening and closing unit 5000 and a 1-2 flap 2220 coupled to the second opening and closing unit 6000.

The plurality of second flaps 2400 may be disposed in the width direction, and may be respectively disposed in the second inlet holes 1450 formed in the cover 1400. That is, the plurality of second flaps 2400 may be disposed below the plurality of first flaps 2200 in the height direction. The second flaps 2400 may open and close the second inlet holes 1450 through the first opening and closing unit 5000 and the second opening and closing unit 6000 of the opening and closing device. The plurality of second flaps 2400 may include a 2-1 flap 2410 coupled to the first opening and closing unit 5000 and a 2-2 flap 2420 coupled to the second opening and closing unit 6000.

Referring to FIGS. 2 and 7, a plurality of fixed blocks 3000 may be provided. The plurality of fixed blocks 3000 may be spaced apart from each other at the same interval as the interval at which the fourth partition frames 1430 of the cover 1400 are spaced apart from each other. The fixed block 3000 is coupled to the fourth partition frame 1430 of the cover 1400 to rotatably fix the first flap 2200 and the second flap 2400 to the cover 1400. More specifically, the fixed block 3000 may be coupled to the second fixing protrusion 1470 of the cover 1400 protruding from the fourth partition frame 1430. Accordingly, the fixed block 3000 may simultaneously fix the 1-1 flap 2210 and the 2-1 flap 2410 to the cover 1400, and may simultaneously fix the 1-2 flap 2220 and the 2-2 flap 2420 to the cover 1400.

As shown in FIG. 7, a disposition direction of the plurality of fixed blocks 3000 may be the same as the disposition direction of the fourth partition frames 1430 of the cover 1400. This is to ensure that the fixed block 3000 allows the first flap 2200 and the second flap 2400 to be rotatably fixed to the cover 1400 and at the same time, to be covered by the cover 1400 to prevent the first flap 2200 and the second flap 2400 from being exposed to the outside, thereby preventing degradation of the design of the front portion of the vehicle that may occur when the fixed block 3000 is visible when the first flap 2200 and the second flap 2400 open the first inlet hole 1440 and the second inlet hole 1450 formed in the cover 1400.

The rotating unit 4000 may include an actuator 4200 that is disposed on an outer surface of the housing 1200 of the case 1000 and generates power to move the first moving block 5200 and the second moving block 6200 to be described below and a cylindrical rotating shaft 4400 connected to the actuator 4200 and rotated by the power generated in the actuator 4200. The rotating shaft 4400 may be rotatably coupled to the case 1000.

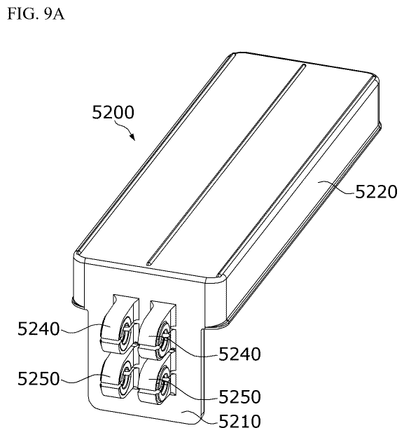

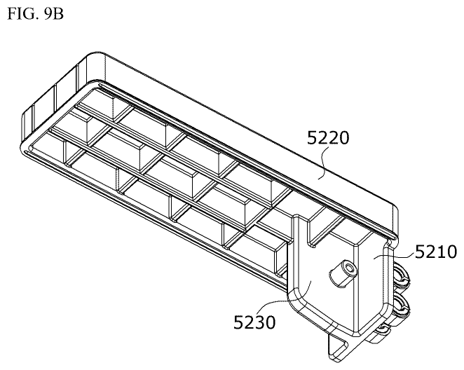

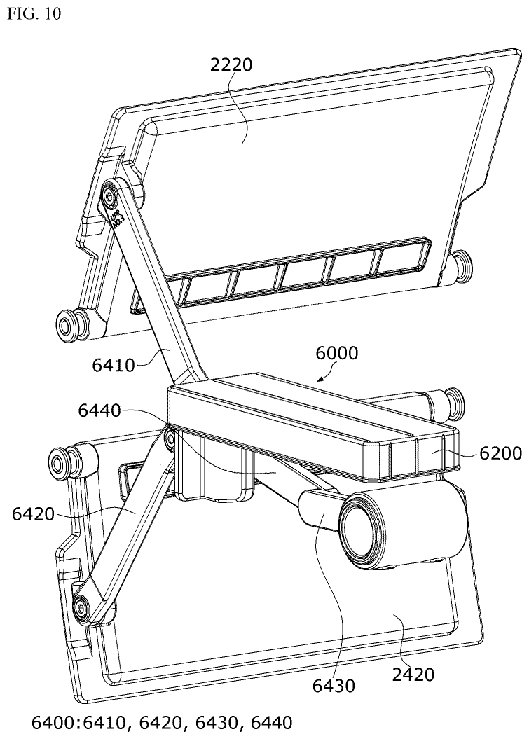

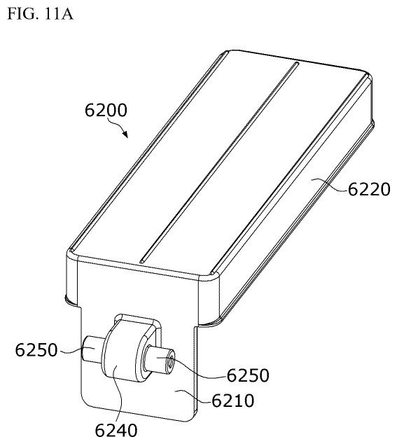

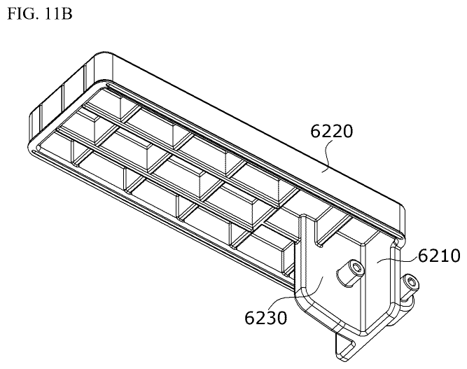

FIG. 8 is a view showing the first opening and closing unit, FIGS. 9A and 9B are views showing a moving block of the first opening and closing unit, FIG. 10 is a view showing the second opening and closing unit, and FIGS. 11A and 11B are a view showing a moving block of the second opening and closing unit.

The opening and closing device may be connected to the flap unit 2000, and may rotate the first flap 2200 and the second flap 2400. The opening and closing device may include a first opening and closing unit 5000 and a second opening and closing unit 6000 that are coupled to the rotating shaft 4400 of the rotating unit 4000 and are simultaneously operated by the rotating shaft 4400. That is, the opening and closing device may prevent degradation of the design of the front portion of the vehicle that may occur by the plurality of first inlet holes 1440 and the plurality of second inlet holes 1450 being opened or closed differently from each other.

Referring to FIGS. 8, 9A, and 9B, the first opening and closing unit 5000 may control the operation of the plurality of first flaps 2200, and may control the operation of the plurality of second flaps 2400. The first opening and closing unit 5000 may include a moving block and a first link unit 5400.

The moving block (hereinafter referred to as the “first moving block 5200”) may be connected to the first flaps 2200 and the second flaps 2400, and may push or pull the first flap link and the second flap link, which will be described below, while moving inside the case 1000. The first moving block 5200 may be moved in the longitudinal direction in conjunction with the first link unit 5400. The first moving block 5200 may include a first body 5210, a second body 5220, a third body 5230, a first support protrusion 5240, and a second support protrusion 5250.

The first body 5210 may be disposed in the height direction. The first body 5210 may support the first support protrusion 5240 and the second support protrusion 5250. In addition, the first body 5210 may be supported by the second body 5220. The first body 5210 may be movably disposed in the 1-1 groove 1242 of the first accommodating portion 1240 of the housing 1200.

The second body 5220 may be connected to the first body 5210, and may be disposed in a direction (longitudinal direction) that perpendicularly intersects with the first body 5210. The second body 5220 may be movably accommodated in the 1-1 groove 1242 and the 1-2 groove 1243 of the first accommodating portion 1240 of the housing 1200. The fact that the second body 5220 is movably accommodated in the 1-1 groove 1242 and the 1-2 groove 1243 of the first accommodating portion 1240 of the housing 1200 may have the effect of improving the stability of the first moving block 5200.

The third body 5230 may have a shape that protrudes downward from the second body 5220 in the height direction from the second body 5220. The third body 5230 may be supported by the first body 5210 and the second body 5220. A protrusion supporting a 2-1 shaft link 5440 to be described below may be disposed on the third body 5230. The protrusion may protrude from the third body 5230 in the width direction.

The first support protrusion 5240 may be disposed on the first body 5210. The first support protrusion 5240 may protrude in the longitudinal direction, and may have a hollow shape. The first support protrusion 5240 may be coupled to a 1-1 flap link 5410 to be described below to support the 1-1 flap link 5410.

The second support protrusion 5250 may be disposed on the first body 5210. The second support protrusion 5250 may protrude in the longitudinal direction, and may have a hollow shape. The second support protrusion 5250 may be coupled to a 2-1 flap link 5420 to be described below to support the 2-1 flap link 5420.

As illustrated in FIGS. 9A and 9B, the first support protrusion 5240 and the second support protrusion 5250 may be disposed in the height direction. More specifically, two second support protrusions 5250 may be disposed on the lower side of two first support protrusions 5240 in the height direction. In this case, one first support protrusion 5240 based on the width direction and one 2-1 support protrusion disposed on the lower side of the 1-1 support protrusion in the height direction should be set as one protrusion unit, and two protrusions on a width direction side of the protrusion unit should be set as another protrusion unit.

The reason for setting two protrusion units as described above is that, among the four protrusions shown in FIG. 9A, when the two protrusions on the upper side in the height direction support the 1-1 flap link 5410 and the 2-1 flap link 5420, the two protrusions on the lower side may not support the first flap 2200 and the second flap 2400.

Therefore, a structure in which the two protrusion units are disposed in the width direction may have the effect of preventing coupling interference between flap links, thereby allowing a plurality of flaps to be simultaneously operated.

The first link unit 5400 may include a first flap link, a second flap link, a first shaft link, and a second shaft link.

The first flap link (hereinafter referred to as the “1-1 flap link 5410”) may be coupled to the first flap 2200. More specifically, the 1-1 flap link 5410 may be coupled to the 1-1 flap 2210 disposed in the first inlet hole 1440 of the cover 1400. A plurality of 1 -1 flap links 5410 may be provided. Each 1-1 flap link 5410 may be connected to an adjacent 1-1 flap 2210. In addition, the 1-1 flap link 5410 may be coupled to the first support protrusion 5240 of the first moving block 5200.

The second flap link (hereinafter referred to as the “2-1 flap link 5420”) may be coupled to the second flap 2400. More specifically, the 2-1 flap link 5420 may be coupled to the 2-1 flap 2410 disposed in the second inlet hole 1450 of the cover 1400. A plurality of 2-1 flap links 5420 may be provided. Each 2-1 flap link 5420 may be connected to an adjacent 2-1 flap 2410. In addition, the 2-1 flap link 5420 may be coupled to the second support protrusion 5250 of the first moving block 5200.

The first shaft link (hereinafter referred to as a “1-1 shaft link 5430”) may be connected to the rotating shaft 4400 of the rotating unit 4000 to rotate according to the rotating shaft 4400. The 1-1 shaft link 5430 may be disposed in the 1-3 groove 1244 of the first accommodating portion 1240 of the housing 1200 in a state of being coupled to the rotating shaft 4400.

The second shaft link (hereinafter referred to as the “2-1 shaft link 5440”) may be coupled to the 1-1 shaft link 5430 and the third body 5230 of the first moving block 5200. The 2-1 shaft link 5440 may be disposed in the 1-3 groove 1244 of the first accommodating portion 1240 of the housing 1200 in a state of being coupled to the 1-1 shaft link 5430. The 2-1 shaft link 5440 may push or pull the first moving block 5200 according to the movement of the 1-1 shaft link 5430 that rotates together with the rotating shaft 4400. That is, the 2-1 shaft link 5440 may be a medium that transmits a rotational force of the rotating shaft 4400 to the first moving block 5200.

Referring to FIGS. 10 and 11, the second opening and closing unit 6000 may control the operation of the first flap 2200, and may control the operation of a plurality of second flaps 2400. The second opening and closing unit 6000 may include a moving block and a second link unit 6400.

The moving block (hereinafter referred to as the “second moving block 6200”) may be connected to the first flap 2200 and the second flap 2400, and may push or pull the first flap link and the second flap link, which will be described below, while moving inside the case 1000. The second moving block 6200 may be moved in the longitudinal direction in conjunction with the second link unit 6400. The second moving block 6200 may include a fourth body 6210, a fifth body 6220, a sixth body 6230, a third support protrusion 6240, and a fourth support protrusion 6250.

The fourth body 6210 may be disposed in the height direction. The fourth body 6210 may support the third support protrusion 6240 and the fourth support protrusion 6250. In addition, the fourth body 6210 may be supported by the fifth body 6220. The fourth body 6210 may be movably disposed in the 2-1 groove 1252 of the second accommodating portion 1250 of the housing 1200.

The fifth body 6220 may be connected to the fourth body 6210, and may be disposed in a direction (longitudinal direction) that perpendicularly intersects with the fourth body 6210. The fifth body 6220 may be movably accommodated in the 2-1 groove 1252 and the 2-2 groove 1253 of the second accommodating portion 1250 of the housing 1200. The fact that the fifth body 6220 is movably accommodated in the 2-1 groove 1252 and the 2-2 groove 1253 of the second accommodating portion 1250 of the housing 1200 may have the effect of improving the stability of the second moving block 6200.

The sixth body 6230 may have a shape that protrudes downward from the fifth body 6220 in the height direction from the fifth body 6220. The sixth body 6230 may be supported by the fourth body 6210 and the fifth body 6220. A protrusion supporting a 2-2 shaft link 6440 to be described below may be disposed on the sixth body 6230. The protrusion may protrude from the sixth body 6230 in the width direction.

The third support protrusion 6240 may be disposed on the fourth body 6210. The third support protrusion 6240 may protrude in the longitudinal direction. The third support protrusion 6240 may support the fourth support protrusion 6250.

The fourth support protrusion 6250 may be disposed on the third support protrusion 6240. The fourth support protrusion 6250 may protrude from the third support protrusion 6240 in the width direction. The fourth support protrusion 6250 may be coupled to a 1-2 flap link 6410 and a 2-2 flap link 6420 to be described below to support the 1-2 flap link 6410 and the 2-2 flap link 6420. A plurality of fourth support protrusions 6250 are provided, and the centers of the plurality of fourth support protrusions 6250 may coincide with each other.

The second link unit 6400 may include a first flap link, a second flap link, a first shaft link, and a second shaft link.

The first flap link (hereinafter referred to as the “1-2 flap link 6410”) may be coupled to the first flap 2200. More specifically, the 1-2 flap link 6410 may be coupled to the 1-2 flap 2220 disposed in the first inlet hole 1440 of the cover 1400. In addition, the 1-2 flap link 6410 may be coupled to the fourth support protrusion 6250 of the second moving block 6200.

The second flap link (hereinafter referred to as the “2-2 flap link 6420”) may be coupled to the second flap 2400. More specifically, the 2-2 flap link 6420 may be coupled to the 2-2 flap 2420 disposed in the second inlet hole 1450 of the cover 1400. In addition, the 2-2 flap link 6420 may be coupled to the fourth support protrusion 6250 of the second moving block 6200.

The first shaft link (hereinafter referred to as a “1-2 shaft link 6430”) may be connected to the rotating shaft 4400 of the rotating unit 4000 to rotate according to the rotating shaft 4400. The 1-2 shaft link 6430 may be disposed in the 2-3 groove 1254 of the second accommodating portion 1250 of the housing 1200 in a state of being coupled to the rotating shaft 4400.

The second shaft link (hereinafter referred to as the “2-2 shaft link 6440”) may be coupled to the 1-2 shaft link 6430 and the sixth body 6230 of the second moving block 6200. The 2-2 shaft link 6440 may be disposed in the 2-3 groove 1254 of the second accommodating portion 1250 of the housing 1200 in a state of being coupled to the 1-2 shaft link 6430. The 2-2 shaft link 6440 may push or pull the second moving block 6200 according to the movement of the 1-2 shaft link 6430 that rotates together with the rotating shaft 4400. That is, the 2-2 shaft link 6440 may be a medium that transmits a rotational force of the rotating shaft 4400 to the second moving block 6200.

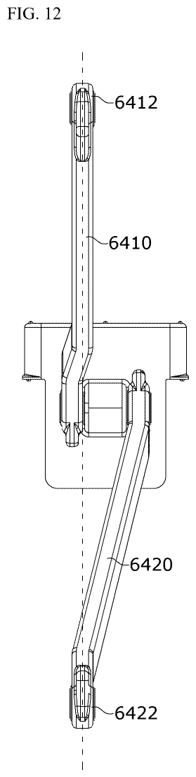

FIG. 12 is a view showing the first flap link and the second flap link of the second opening and closing unit.

Referring to FIG. 12, the 1-2 flap link 6410 may include a first coupling hole 6412, and the 2-2 flap link 6420 may include a second coupling hole 6422. Here, the first coupling hole 6412 and the second coupling hole 6422 may be disposed on the same line in the height direction. This is a result that may be obtained by disposing the 2-2 flap link 6420 to be inclined with respect to the 1-2 flap link 6410. The shape of the 2-2 flap link 6420 is intended to prevent operational interference with the 1-2 flap link 6410 so that the 1-2 flap 2220 and the 2-2 flap 2420 may be smoothly opened and closed.

Hereinafter, a process in which the first opening and closing unit 5000 simultaneously rotates the 1-1 flap 2210 and the 2-1 flap 2410, and the second opening and closing unit 6000 simultaneously rotates the 1-2 flap 2220 and the 2-2 flap 2420, thereby simultaneously opening the first inlet hole 1440 and the second inlet hole 1450 is described.

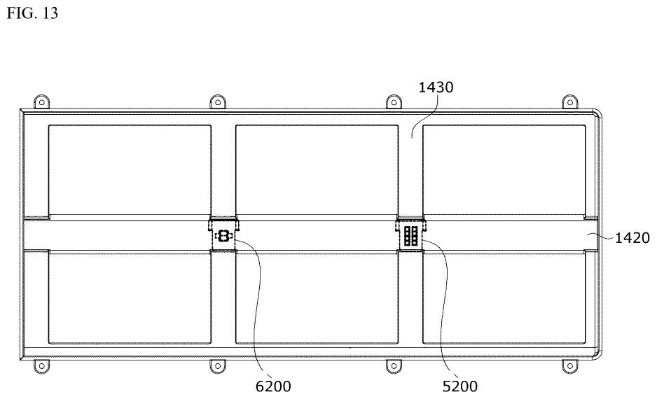

FIG. 13 is a view showing a state where the moving block of the first opening and closing unit and the moving block of the second opening and closing unit are covered by the cover.

Referring to FIG. 13, the first moving block 5200 and the second moving block 6200 may be obscured by the third partition frame 1420 of the cover 1400. Accordingly, degradation of design quality of the front portion of the vehicle in a state where the first inlet hole 1440 and the second inlet hole 1450 are open by the rotation of the first flap 2200 and the second flap 2400 may be prevented.

In FIG. 13, the first moving block 5200 and the second moving block 6200 are exemplified as being covered by the third partition frame 1420 of the cover 1400, but the present invention is not limited thereto. The first moving block 5200 and the second moving block 6200 may be obscured by the fourth partition frame 1430 in addition to the third partition frame 1420.

Hereinafter, a process of opening the first inlet hole 1440 and the second inlet hole 1450 is described. In the present description, the movement of the first opening and closing unit 5000 will be described, followed by the movement of the second opening and closing unit 6000 that simultaneously operates.

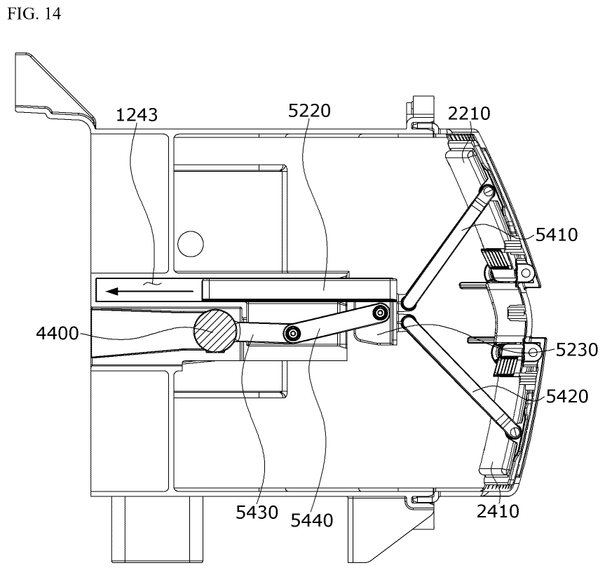

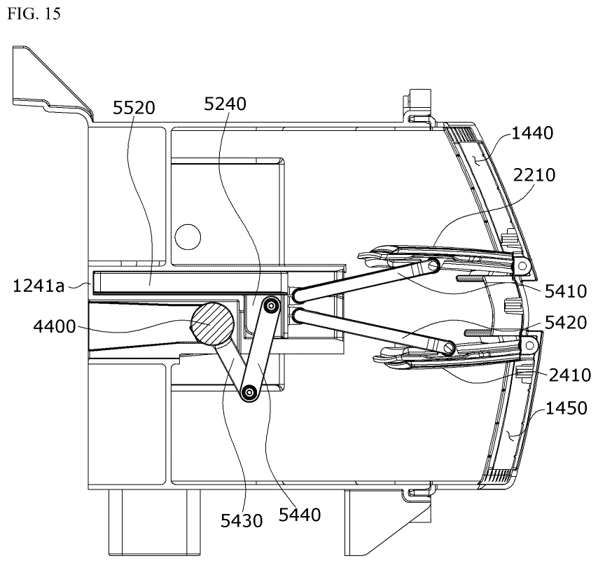

FIG. 14 is a view showing a state where the first opening and closing unit closes the first inlet hole and the second inlet hole, and FIG. 15 is a view showing a state where the first opening and closing unit opens the first inlet hole and the second inlet hole.

Referring to FIGS. 14 and 15, first, in a state where the 1-1 flap 2210 closes the first inlet hole 1440 and the 2-1 flap 2410 closes the second inlet hole 1450, when the rotating shaft 4400 is rotated by the actuator 4200, the 1-1 shaft link 5430 of the first opening and closing unit 5000 coupled to the rotating shaft 4400 rotates together with the rotating shaft 4400, and the 1-1 shaft link 5430 pulls the 2-1 shaft link 5440 toward the rotating shaft 4400. When the 2-1 shaft link 5440 is pulled toward the rotating shaft 4400 by the 1-1 shaft link 5430, the 2-1 shaft link 5440 pulls the third body 5230 of the first moving block 5200. In this way, the first moving block 5200 moves toward the rotating shaft 4400.

Since the second body 5220 of the first moving block 5200 is in a state of being movably accommodated in the 1-2 groove 1243 of the first accommodating portion 1240 of the housing 1200, the first moving block 5200 moves toward the rotating shaft 4400 inside the 1-2 groove 1243. In this case, since the first moving block 5200 moves toward the rotating shaft 4400, the 1-1 flap link 5410 and the 2-1 flap link 5420 connected to the first moving block 5200 are pulled by the first moving block 5200.

The 1-1 flap link 5410 coupled to the first support protrusion 5240 of the first moving block 5200 rotates around the first support protrusion 5240 in the process of moving toward the rotating shaft 4400, and the 2-1 flap link 5420 coupled to the second support protrusion 5250 of the first moving block 5200 rotates around the second support protrusion 5250 in the process of moving toward the rotating shaft 4400. Thereby, the 1-1 flap 2210 coupled to the 1-1 flap link 5410 rotates to open the first inlet hole 1440, and the 2-1 flap 2410 coupled to the 2-1 flap link 5420 rotates to open the second inlet hole 1450.

In this case, as shown in FIG. 15, the 1-1 flap 2210 and the 2-1 flap 2410 rotate to come closer to each other. Accordingly, the first inlet hole 1440 and the second inlet hole 1450 are opened. Here, the second body 5220 of the first moving block 5200 comes into contact with the first stopper frame 1241a of the first accommodating portion 1240 of the housing 1200, so that its movement is blocked.

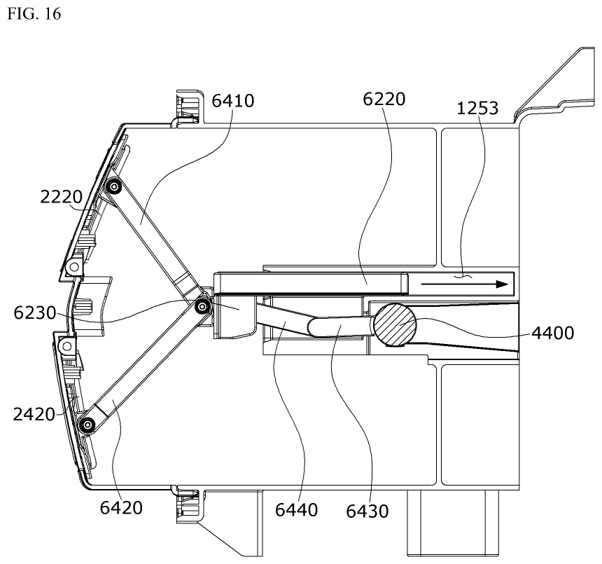

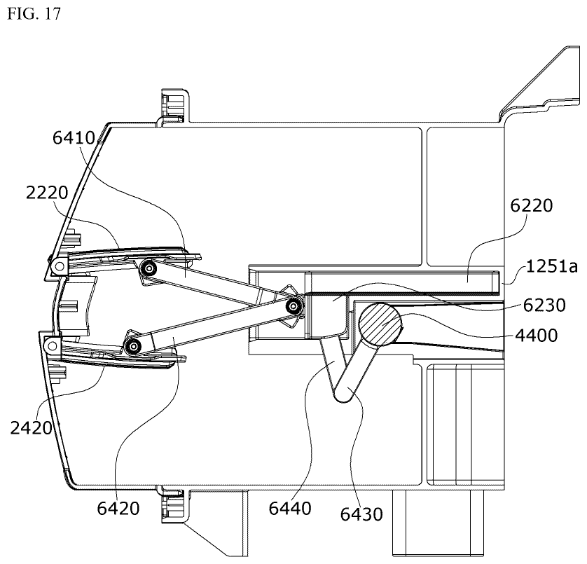

FIG. 16 is a view showing a state where the second opening and closing unit closes the first inlet hole and the second inlet hole, and FIG. 17 is a view showing a state where the second opening and closing unit opens the first inlet hole and the second inlet hole.

Referring to FIGS. 16 and 17, the first opening and closing unit 5000 rotates the 1-1 flap 2210 and the 2-1 flap 2410, while the second opening and closing unit 6000 rotates the 1-2 flap 2220 and the 2-2 flap 2420.

More specifically, in a state where the 1-2 flap 2220 closes the first inlet hole 1440 and the 2-2 flap 2420 closes the second inlet hole 1450, when the rotating shaft 4400 is rotated by the actuator 4200, the 1-2 shaft link 6430 of the second opening and closing unit 6000 coupled to the rotating shaft 4400 rotates together with the rotating shaft 4400, and the 1-2 shaft link 6430 pulls the 2-2 shaft link 6440 toward the rotating shaft 4400. When the 2-2 shaft link 6440 is pulled toward the rotating shaft 4400 by the 1-2 shaft link 6430, the 2-2 shaft link 6440 pulls the sixth body 6230 of the second moving block 6200. In this way, the second moving block 6200 moves toward the rotating shaft 4400.

Since the fifth body 6220 of the second moving block 6200 is in a state of being movably accommodated in the 2-2 groove 1253 of the second accommodating portion 1250 of the housing 1200, the second moving block 6200 moves toward the rotating shaft 4400 inside the 2-2 groove 1253. In this case, since the second moving block 6200 moves toward the rotating shaft 4400, the 1-2 flap link 6410 and the 2 -2 flap link 6420 connected to the second moving block 6200 are pulled by the first moving block 5200.

The 1-2 flap link 6410 and the 2-2 flap link 6420 coupled to the fourth support protrusion 6250 of the second moving block 6200 rotate around the first support protrusion 5240 in the process of moving toward the rotating shaft 4400. Thereby, the 1-2 flap 2220 coupled to the 1-2 flap link 6410 rotates to open the first inlet hole 1440, and the 2-2 flap 2420 coupled to the 2-2 flap link 6420 rotates to open the second inlet hole 1450.

In this case, as shown in FIG. 17, the 1-2 flap 2220 and the 2-2 flap 2420 rotate to come closer to each other. Accordingly, the first inlet hole 1440 and the second inlet hole 1450 are opened. Here, the fourth body 6210 of the second moving block 6200 comes into contact with the second stopper frame 1251a of the second accommodating portion 1250 of the housing 1200, so that its movement is blocked.

In this way, the vehicle air flap system 1 according to one embodiment of the present invention may open a plurality of inlet holes arranged in the height direction at once. Therefore, the design degradation of the front portion of the vehicle may be prevented compared to the air flap system in the related art in which each of a plurality of inlet holes is opened at a different time.

Referring to FIGS. 15 and 17, the first flap 2200 that has rotated to open inlet holes of the first row (the first inlet holes 1440) and the second flap 2400 that has rotated to open the inlet holes of the second row (the second inlet holes 1450) may be disposed inside the cover 1400 and the housing 1200.

More specifically, the driving wind generated when the vehicle is traveling moves toward the vehicle in a direction opposite to a direction in which the vehicle is traveling. Therefore, the driving wind flows into the interior of the housing 1200 through the cover 1400 and then moves toward internal components of the vehicle. In this process, since the first flap 2200 and the second flap 2400, which open the first inlet hole 1440 and the second inlet hole 1450, are disposed toward the interior of the housing 1200, the driving wind simultaneously flows into the interior of the cover 1400 through the first inlet hole 1440 and the second inlet hole 1450.

When the first flap 2200 and the second flap 2400 are disposed toward the outside of the cover 1400, the air flowing into the interior of the cover 1400 through the first inlet hole 1440 and the second inlet hole 1450 may collide with each other to generate a vortex inside the cover 1400 and the housing 1200. This may result in impeding the movement of the driving wind that continuously flows into the interior of the cover 1400, thereby delaying cooling of the internal components of the vehicle. Accordingly, the first flap 2200 and the second flap 2400 disposed toward the interior of the housing 1200 prevent the formation of a vortex that may be generated by the driving wind flowing into the interior of the cover 1400, thereby preventing cooling delay of the internal components of the vehicle and preventing overheating of the engine of the vehicle.

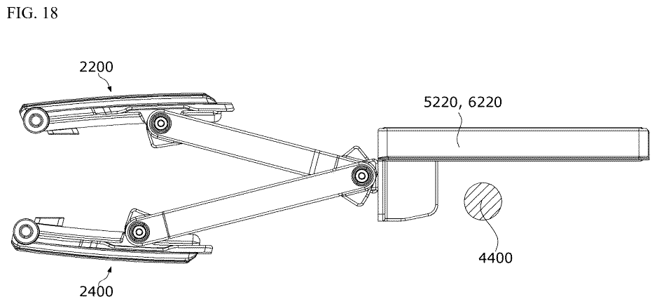

FIG. 18 is a view showing a state where a portion of the moving block is disposed at the rear of the rotating shaft.

Referring to FIG. 18, in the state where the first flap 2200 and the second flap 2400 open the inlet holes of the first row (the first inlet holes 1440) and the inlet holes of the second row (the second inlet holes 1450), a portion (the second body 5220) of the first moving block 5200 and a portion (the fourth body 6210) of the second moving block 6200 may be disposed at the rear of the rotating shaft 4400 in a direction in which the first moving block 5200 and the second moving block 6200 move.

With this structure, an operating distance of the vehicle air flap system 1 in the longitudinal direction may be reduced, so that the vehicle air flap system 1 may not cause interference with internal components of the vehicle.

According to one embodiment of the present invention, since a flap is not disposed to be stepped with a cover, it is possible to prevent degradation of the design of a front portion of a vehicle.

Although the embodiments of the present invention have been described above, it is understood that one ordinary skilled in the art can make various changes and modifications to the present invention without departing from the spirit and scope of the present invention as hereinafter claimed. Further, it should be construed that differences associated with such changes and modifications fall within the scope of the present invention defined by the accompanying claims.

What is claimed is:

1. A vehicle air flap system comprising:
a case including a cover in which a plurality of inlet holes disposed in parallel in each of a first row and a second row are formed;
a flap unit including a plurality of first flaps disposed in the inlet holes of the first row and a plurality of second flaps disposed in the inlet holes of the second row; and
at least one opening and closing device connected to the flap unit and configured to rotate the first flaps and the second flaps,
wherein the at least one opening and closing device includes:
a first flap link, a first end portion of which is pivotally coupled to the first flaps;
a second flap link, a first end portion of which is pivotally coupled to the second flaps; and
a moving block, a first end portion of which is pivotally connected to second end portions of the first flap link and the second flap link and configured to push or pull the first flap link and the second flap link while moving inside the case.

2. The vehicle air flap system of claim 1, further including:
a rotating shaft rotatably coupled to the case,
wherein the at least one opening and closing device includes a first opening and closing unit and a second opening and closing unit that are coupled to the rotating shaft and are simultaneously operated by the rotating shaft.

3. The vehicle air flap system of claim 2, wherein in a state where the first flaps and the second flaps open the inlet holes of the first row and the inlet holes of the second row, a second end portion of the moving block is disposed at a rear of the rotating shaft in a direction in which the moving block moves.

4. The vehicle air flap system of claim 2,
wherein the case further includes a housing that is coupled to the cover and accommodates the at least one opening and closing device therein, and
wherein the moving block includes a body to which the second end portions of the first flap link and the second flap link are pivotally coupled, and
wherein the housing includes a groove to which the body of the moving block is slidably engaged.

5. The vehicle air flap system of claim 4, wherein the at least one opening and closing device further includes:
a first shaft link, a first end portion of which is connected to the rotating shaft to rotate according to the rotating shaft; and
a second shaft link, a first end portion of which is pivotally connected to a second end portion of the first shaft link, and a second end portion of which is pivotally connected to the first end portion of the moving block to push or pull the moving block according to movement of the first shaft link.

6. The vehicle air flap system of claim 5,
wherein the housing includes:
a first accommodating portion configured to accommodate a second end portion of the moving block of the first opening and closing unit therein to be linearly movable; and
a second accommodating portion configured to accommodate a second end portion of the moving block of the second opening and closing unit therein to be linearly movable.

7. The vehicle air flap system of claim 6,
wherein the first accommodating portion includes a first groove to slidably accommodate the second end portion of the moving block of the first opening and closing unit; and
wherein the second accommodating portion includes a second groove to slidably accommodate the second end portion of the moving block of the second opening and closing unit.

8. The vehicle air flap system of claim 7,
wherein the first accommodating portion further includes a third groove to which second end portions of corresponding first and second flap links are selectively accommodated into the third groove according to movement of the moving block of the first opening and closing unit, and
wherein the second accommodating portion further includes a fourth groove to which second end portions of corresponding first and second flap links are selectively accommodated into the fourth groove according to movement of the moving block of the second opening and closing unit.

9. The vehicle air flap system of claim 7,
wherein the housing of the case includes:
a first partition frame partitioning an internal space of the housing to form a plurality of air passage regions; and
a second partition frame disposed to intersect the first partition frame and partitioning each of the plurality of air passage regions into a plurality of sections, and
wherein the cover of the case includes:
a third partition frame forming the inlet holes of the first row and the inlet holes of the second row; and
a fourth partition frame partitioning each of the inlet holes of the first row and the inlet holes of the second row into a plurality of sections.

10. The vehicle air flap system of claim 7, wherein the vehicle air flap system further includes a fixed block that is coupled to the fourth partition frame of the cover and rotatably fixes the first flaps and the second flaps to the cover.

11. The vehicle air flap system of claim 9, wherein a disposition direction of the fixed block is the same as a disposition direction of the fourth partition frame of the cover.

12. The vehicle air flap system of claim 1, wherein the first flaps that are rotated to open the inlet holes of the first row and the second flaps that are rotated to open the inlet holes of the second row are disposed inside the cover and the housing.

13. The vehicle air flap system of claim 1, wherein the second end portions of the first flap link and the second flap link are coaxially coupled to the first end portion of the moving block.

14. The vehicle air flap system of claim 13, wherein at least one of the first flap link and the second flap link is inclined so that the first end portions of the first flap link and the second flap link are aligned in a same virtual line.

15. The vehicle air flap system of claim 1, wherein the second end portions of the first flap link and the second flap link are spaced from each other in a height direction and pivotally coupled to the first end portion of the moving block.
